(19) United States
(12) Patent Application Publication
(10) Pub. No.: US 2015/0248689 A1
(43) Pub. Date: Sep. 3, 2015

(54) SYSTEMS AND METHODS FOR PROVIDING TRANSPORTATION DISCOUNTS

(71) Applicants: Sunil Paul, San Francisco, CA (US); Jahan Khanna, San Francisco, CA (US); Robert Moran, San Francisco, CA (US); Thomas Gellatly, San Francisco, CA (US); Lee Fastenau, San Francisco, CA (US); Brian Romanko, San Francisco, CA (US); David Zhang, San Francisco, CA (US); Robert Wong, Burlingame, CA (US)

(72) Inventors: Sunil Paul, San Francisco, CA (US); Jahan Khanna, San Francisco, CA (US); Robert Moran, San Francisco, CA (US); Thomas Gellatly, San Francisco, CA (US); Lee Fastenau, San Francisco, CA (US); Brian Romanko, San Francisco, CA (US); David Zhang, San Francisco, CA (US); Robert Wong, Burlingame, CA (US)

(21) Appl. No.: 14/637,360

(22) Filed: Mar. 3, 2015

Related U.S. Application Data
(60) Provisional application No. 61/947,057, filed on Mar. 3, 2014.

(51) Int. Cl. G06Q 30/02; G06Q 50/30

(52) U.S. Cl. CPC G06Q 30/0222; G06Q 50/30

(57) ABSTRACT

Systems and methods for providing transportation discounts are disclosed. A server receives, from a client device of a user, a request for a transportation service. In response, the server identifies that the request relates to a particular characteristic associated with modified pricing. The server then calculates an adjusted price for the transportation service based on the modified pricing associated with the particular characteristic.

### CROSS-REFERENCE TO RELATED APPLICATIONS

This application claims the benefit of priority to U.S. Provisional Patent Application entitled “Systems and Methods for Providing Transportation Discounts,” Ser. No. 61/947,057, filed Mar. 3, 2014, which is hereby incorporated herein by reference in its entirety.

### TECHNICAL FIELD

The present disclosure generally relates to transportation services and, more specifically, to systems and methods for providing transportation discounts.

### BRIEF DESCRIPTION OF THE DRAWINGS

Some embodiments are illustrated by way of example and not of limitation in the figures of the accompanying drawings.

FIG. 1 is a schematic diagram showing an example of a system for providing a transportation marketplace, according to some embodiments;

FIG. 2 is a block diagram showing example components of a transportation server, according to some embodiments;

FIG. 3 is a block diagram showing example components of a client device, according to some embodiments;

FIG. 4 is a flowchart showing an example method of providing transportation discounts, according to some embodiments; and

FIG. 5 is a block diagram of a machine in the example form of a computer system within which a set of instructions, for causing the machine to perform any one or more of the methodologies discussed herein, may be executed, according to some embodiments.

FIG. 6 depicts a block diagram of an exemplary data structure for the driver record data for storing driver profiles at the transportation server, in accordance with some example embodiments.

FIG. 7 illustrates an exemplary user interface of a client device for requesting a ride.

FIG. 8 illustrates an exemplary user interface of a client device for reviewing discount options.

FIG. 9 illustrates an exemplary user interface of a client device for reviewing promotional deals.

FIG.10 is a block diagram showing an example system for providing transportation discounts.

FIG. 11 is a flow diagram illustrating a method, in accordance with some example embodiments, for providing discounts in a transportation service.

FIG. 12 is a flow diagram illustrating a method, in accordance with some example embodiments, for generating passenger discounts in a transportation service.

### DETAILED DESCRIPTION

Example systems and methods for providing transportation discounts are described. In the following description, for purposes of explanation, numerous specific details are set forth in order to provide a thorough understanding of example embodiments. It will be evident, however, to one skilled in the art that the present technology may be practiced without these specific details.

A transportation server provides an online environment in which drivers and passengers connect with one another for transportation services. For example, a passenger uses a software application on the passenger's computing device to request transportation from Location A to Location B. When the request is sent from the passenger's computing device to the transportation server, one or more drivers are notified of the request for transportation through a software application on the driver's computing device, and a driver chooses to provide the transportation service requested. The transportation server facilitates payment between the driver and the passenger for the transportation service.

In some embodiments, transportation services are provided to passengers at a discount or at a premium rate, which is automatically and dynamically based on any suitable characteristics and/or factors associated with the particular transportation service requested. For example, a particular request for transportation is fulfilled at a discounted rate based on a location of a driver and/or a location of a passenger near the time of the transportation request, based on a destination associated with the transportation request, and the like. Providing adjusted pricing creates a capability to discount or otherwise modify the characteristics of a trip based on identifying a location relating to a driver and/or passenger (e.g., a pickup location, a drop-off location, etc.) as a hotspot location associated with the adjusted pricing. In some embodiments, a hotspot location is a geographical location of any suitable size (e.g., a particular radius around a city center, a landmark, a neighborhood, etc.) that is associated with adjusted pricing (e.g., a discount) adjustable based on characteristics of a transportation request.

The transportation server determines whether a requested transportation service is associated with a hotspot location (e.g., travels through a hotspot, travels within a hotspot, etc.) based on any suitable factors, such as the particular pickup and drop-off location requested by the passenger, a passenger's location near the time of the request (e.g., using a service for detecting a location of a passenger's computing device, such as global positioning system (GPS)), a drop-off location estimated based on a passenger's calendar entry or any other suitable predictive technology, a drop-off location determined by a driver based on any variety and/or combination of user inputs (e.g., advice from a passenger, an intermediate stop requested and/or required by a driver and/or passenger, a driver indicating the end of a trip, etc.), and the like.

A hotspot location may be established in any suitable manner, such as by a sponsor responsible for a monetary discount associated with the hotspot location, a driver, a passenger, the transportation server, an entity associated with a pickup and/or drop-off location, a crowd-sourced decision-making manner of determining a hotspot location (e.g., through a voting system), an entity in a rewards program who is rewarded by being given the ability to set a particular hotspot location (e.g., which in some embodiments may be automated), a third-party associated with any of the above, and the like.

A discount and/or premium associated with a hotspot location may be calculated, generated, and/or determined by any suitable factors and/or entities. Examples of factors and/or entities capable of calculating, generating, and/or determining a discount and/or premium include any of the following or combination of the following, but are not limited to:
A driver, a passenger, a transportation server, and/or an entity associated with a pickup and/or drop-off location
A third party associated with one of the above
The mode of travel (e.g., a car, truck, etc.)
The number of fellow passengers (e.g. can provide a group discount for bringing more than a particular number of people)
Whether the trip involves a fare split;
Whether the fellow passengers are new to the transportation marketplace
Whether content is shared on any social network;
Whether a special code word is entered as the destination;
The status of the passenger (e.g. status level in a frequent buyer program)
Whether the passenger offers information about their next expected trip;
Whether an intermediate stop is required from the pickup to the drop-off
Whether the passengers are connected by a social network and/or the degree of connection;
Whether an entity associated with a drop-off location is connected by a particular number of degrees of social media connection;
Whether the driver is has been added to a list of favorite drivers by the passenger, or vice versa
Whether there is excess or slack demand for trips from the pickup to the drop-off location;
Whether there is a prediction of excess or slack demand for trips when the trip to the drop-off location ends
Whether the driver can expect a return trip or would require a dead head→do we think there will be a ride from there back?
Whether the driver can expect a trip from the drop-off location to a subsequent location having a higher or lower cost for the driver
Weather conditions at pickup locations, drop-off locations, intermediate stops, and the like
Events such as games, concerts, parties, and the like→
Holidays
Demographics or psychographics of the passenger and/or driver→
The number of prior trips by the passenger
The number of prior trips by the driver
The number of prior trips to or from the drop-off location in a particular time period;
A combination of a trip and a transaction
A combination of a trip and time of day, day of week, and/or other time-based event

In some embodiments, a passenger receives a confirmation of the discount in the passenger's application and/or on another form of media (e.g., email receipt, social network, etc.).

In some embodiments, when a discount is provided, the amount can be fully or partially paid by an entity other than the transportation server. For example, the discount is fully or partially paid by the entity that established the hotspot (e.g., a business). In some embodiments, an entity pays for the discount using a percentage of goods and/or services sold to a passenger. In some embodiments, when a premium is charge, the premium amount is distributed fully or partially to an entity.

In one example of a discount and/or premium, a theater provides discounts to passengers who go to the theater and purchase a ticket. In another example of a discount and/or premium, a city decides to automatically charge a premium for pickups within a city center during rush hour, where the pickups involve a number of passengers that is lower than a particular threshold (e.g., a pickup that does not involve more than two passengers).

In some embodiments, validation of the discount occurs. Validation of a discount occurs in any suitable manner, such as the following:
Electronic linking through a common credit card payment, payment exchange, and/or bank
Electronic linking through a virtual currency, virtual currency purse, and/or virtual currency exchange
A confirmation signal sent by the discount provider or authorized third party
Scanning of various sorts (e.g., NFC, RFID, barcodes, etc.)
A geo-located “check-in” to a particular location (e.g., through a third-party service or through the transportation server)
Validation by showing an image to a passenger and/or driver (e.g. validation is showing a photo of a tiger)
Validation by an image of the passenger that is confirmed by an agent at the drop-off location (e.g., validation by an employee of a business to which the passenger is taken)
Providing an electronic receipt (e.g. e-mail)

In some embodiments, the pickup location and/or drop-off location is geographically-defined boundaries instead of a singular point (e.g., the western end of a park where a large concert is being held).

In some embodiments, adjusting pricing based on a popular destination is used as a guideline for drivers rather than an automated or mandatory pricing change.

In some embodiments, the pickup and/or drop-off location is in three-dimensional space (e.g., the 7^{th} floor of a particular building).

The following is a list of non-limiting examples for providing discount and/or premium pricing for a transportation service:
Theater X, which already offers parking validation, now offers validation through the transportation server. When a passenger enters “Theater X” as the destination, that destination-passenger is stored in a database and associated w/the passenger and the driver. Passengers redeem the discount by sending an electronic receipt or by using the same credit card as used for the transportation server through the transportation server.
The transportation server charges a premium for trips ending near a large concert because demand for that destination is large and return trips are slight.
The transportation server provides a discount for trips ending in an area of a city near a baseball stadium because a baseball game will let out at about the time of arrival and demand will be high there.
Discounts on all electric vehicles going to an environmental festival.
Instead of hiring a valet, a party host sets up a hotspot location, providing free rides if the host's hotspot location is the destination and entered as the party host's name.
A restaurant offers free rides home if your credit card bill shows you've purchased more than two alcoholic drinks The transportation server automatically identifies the situation and the discount.
A discount is provided because the pickup and drop-off locations were determined by examination of the passenger's calendar and scheduled in advance.
The transportation server sells a business a level of guaranteed traffic for an advance payment. The discounts are then managed to achieve the traffic. For example, we offer all passengers being dropped off within 0.25 miles of a store a 10% discount if they go into the store to validate.
The transportation server automatically sets rides to a particular business to zero when the driver is an employee of that business and the passenger is an employee of that business.
A high-status passenger (e.g., based on ratings) can set a hotspot location and get discounts when friends travel there. In some embodiments, the high-status passenger only gets the hotspot-setting capability if the passenger is a top passenger for the month.
A retailer's point-of-sale (POS) system automatically detects that sales goals are not being met and increases the incentive to take a trip to that location by setting the location as a hotspot location.
An advertisement-driven autonomous vehicle advertises via the transportation server when a prospective passenger enters a destination near one of their advertisers.
Advertisements appear in the ride feed of the software application to offer discounts for particular trips if accompanied by a purchase.
The transportation server runs a promotion for the most popular destinations of the week. Whichever destination wins will be set as a hotspot location and associated with a discount for the following week. To win, passengers can use a transportation service provided via the transportation server to the most popular destinations, and the winning destination will have the most trips.
The transportation server enables a restaurant to call a car and put the amount on the client's bill.
A lodging host (e.g., bed and breakfast host) who refers a new person to the transportation server gets a payment or credit. In some embodiments, the new person also gets a credit. This may be automatic (e.g., with no promo code required).

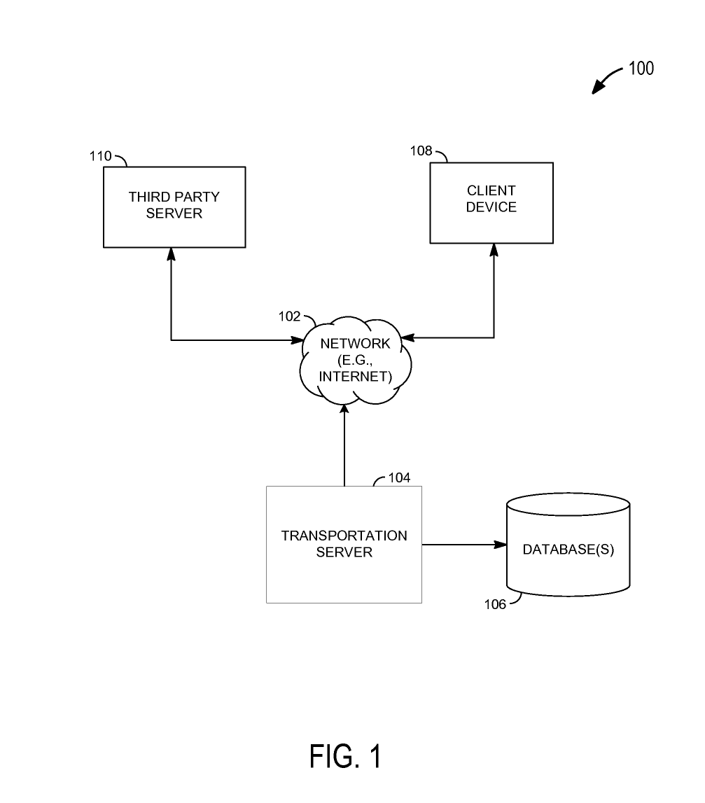

FIG. 1 is a schematic diagram showing an example of a system 100 for providing a transportation marketplace. The system 100 includes a transportation server 104, one or more client devices 108, and a third party server 110. The components of the system 100 are connected directly or over a network 102, which can be any suitable network. In various embodiments, one or more portions of the network 102 includes an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks.

The transportation server 104 includes a network-addressable computing system that facilitates communication between drivers and passengers and obtains and utilizes data relevant to drivers and/or passengers stored in the database(s) 106.

The client device 108 is any suitable computing device used by a driver and/or a passenger to communicate with one another, such as a smart phone, a personal digital assistant (PDA), a mobile phone, a personal computer, a laptop, a computing tablet, or any other device suitable for communication.

The third party server 110 is any server accessed by the transportation server 104 and/or the client device 108 to obtain information relevant to transportation services (e.g., public transportation, location-based services, etc.).

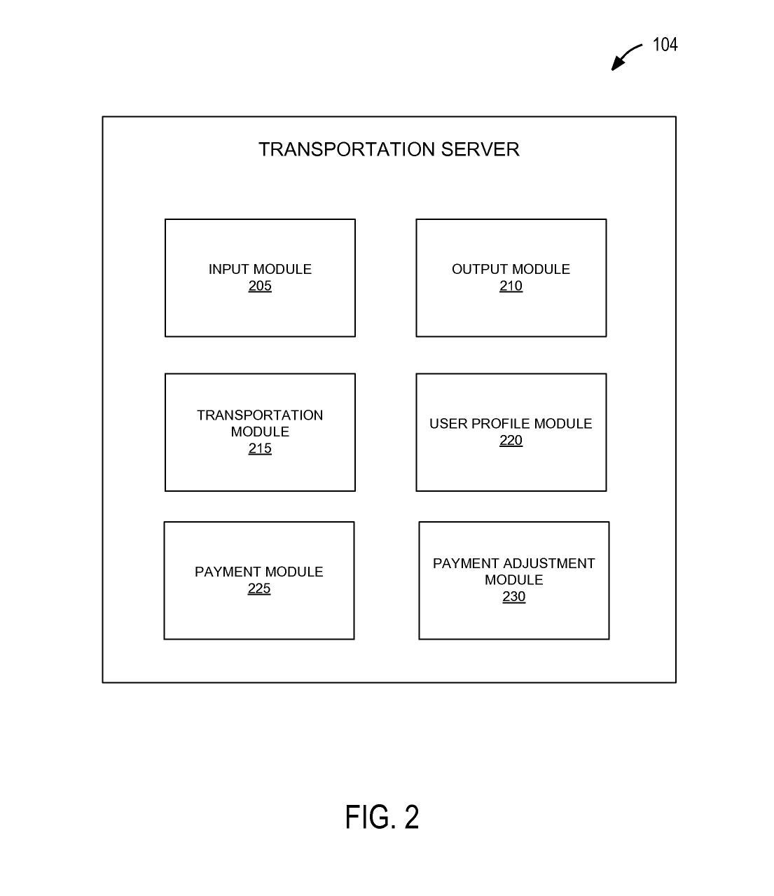

FIG. 2 is a block diagram showing example components of a transportation server 104. The transportation server 104 includes an input module 205, an output module 210, a transportation module 215, a user profile module 220, a payment module 225, and a payment adjustment module 230.

The input module 205 is a hardware-implemented module which receives and processes any inputs from one or more components of system 100 of FIG. 1 (e.g., one or more client devices 108, third party server 110, etc.). The inputs include requests related to transportation, payment information, and the like.

The output module 210 is a hardware-implemented module which sends any outputs to one or more components of system 100 of FIG. 1 (e.g., one or more client devices 108, third party server 110, etc.). The outputs include information about available drivers, passengers requesting transportation, and the like.

The transportation module 215 is a hardware-implemented module which manages, facilitates, and controls transportation requests from passengers and/or drivers. For example, when a request for transportation is received from a passenger, the transportation module 215 determines and generate a list of drivers available to fulfill the request.

The user profile module 220 is a hardware-implemented module which manages, controls, stores, and accesses information associated with drivers and/or passengers. The information can be stored in and accessed from the database(s) 106 shown in FIG. 1. The information managed by the user profile module 220 includes any information associated with a driver and/or passenger, such as preferences, vehicle information, background information of a driver, ratings of drivers and/or passengers, payment information of drivers and/or passengers, and the like.

The payment module 225 is a hardware-implemented module which manages, facilitates, and controls payments between drivers and passengers. The payment module 225 also determines suggested prices associated with transportation requests based on the characteristics of the request (e.g., distance to be traveled, etc.).

The payment adjustment module 230 is a hardware-implemented module which manages, facilitates, determines, identifies, and calculates adjustment payments (e.g., a discount, a premium, etc.) based on characteristics of the transportation service requested by a passenger.

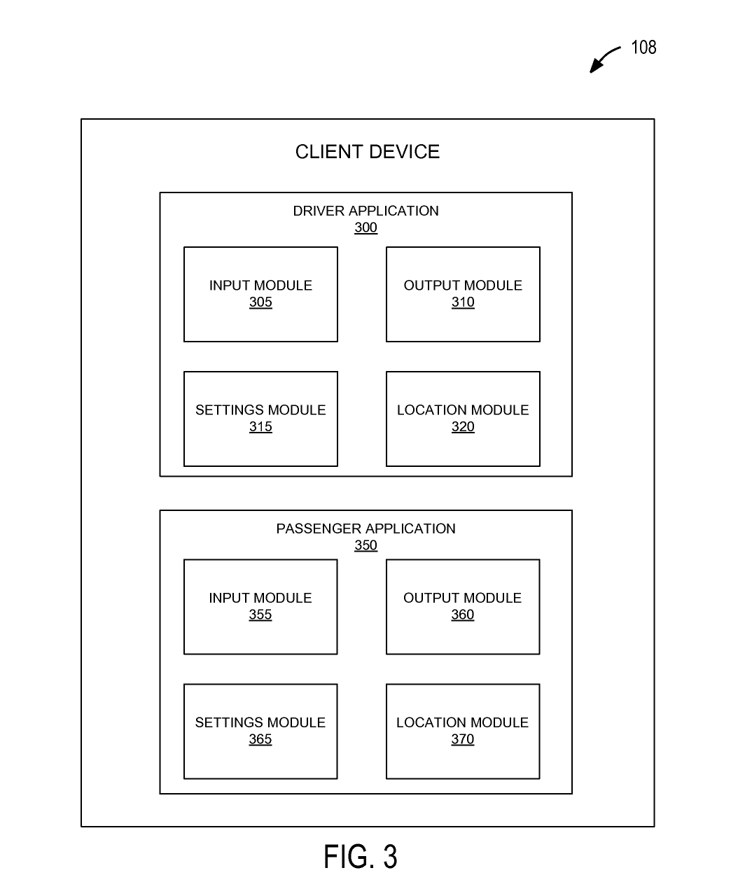

FIG. 3 is a block diagram showing example components of a client device 108. The client device is a computing device of a driver and/or a passenger and includes a driver application 300 and/or a passenger application 350.

The driver application 300 is a software application associated with the transportation server 104 of FIGS. 1-2. The driver application includes an input module 305, an output module 310, a settings module 315, and a location module 320.

The input module 305 is a hardware-implemented module that receives and processes any inputs from a driver, including inputs related to responses to transportation requests from a passenger, inputs related to preferences of the driver, and the like.

The output module 310 is a hardware-implemented module that sends any outputs to one or more components of system 100 of FIG. 1 (e.g., other client devices 108, third party server 110, transportation server 104, etc.). The outputs include responses to transportation requests, location of the client device 108, and the like.

The settings module 315 is a hardware-implemented module that manages, stores, and accesses settings indicated by a driver, such as pickup location, drop-off location, price, a rating of a passenger, a casual carpool preference, and the like.

The location module 320 is a hardware-implemented module that determines a location of the client device 108. The location module 320 determines location in any suitable manner (e.g., using a third party server 110, GPS capabilities on the client device 108, etc.).

The passenger application 350 is a software application associated with the transportation server 104 of FIGS. 1-2. The passenger application includes an input module 355, an output module 360, a settings module 365, and a location module 370.

The input module 355 is a hardware-implemented module that receives and processes any inputs from a passenger, including inputs related to a transportation request, inputs related to preferences of the passenger, and the like.

The output module 360 is a hardware-implemented module that sends any outputs to one or more components of system 100 of FIG. 1 (e.g., other client devices 108, third party server 110, transportation server 104, etc.). The outputs include transportation requests, location of the client device 108, and the like.

The settings module 365 is a hardware-implemented module that manages, stores, and accesses settings indicated by a passenger, such as a pickup location, a drop-off location, a price preference, a driver rating, a driver response rate, a casual carpooling preference, a preferred estimated time of arrival, and the like.

The location module 370 is a hardware-implemented module that determines a location of the client device 108. The location module 320 determines location in any suitable manner (e.g., using a third party server 110, GPS capabilities on the client device 108, etc.).

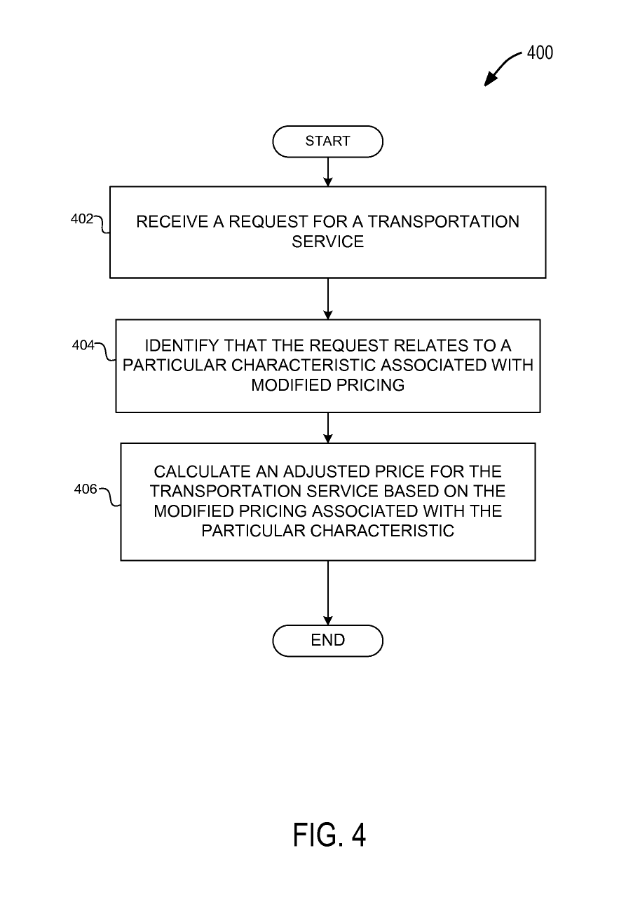

FIG. 4 is a flowchart showing an example method 400 of providing transportation discounts. The operations of FIG. 4 is performed by components of the transportation server 104 of FIG. 2.

In operation 402, the hardware-implemented input module 205 receives a request for a transportation service from a computing device of a passenger.

In operation 404, the hardware-implemented payment adjustment module 230 identifies that the request relates to a particular characteristic associated with modified pricing. For example, the particular characteristic relates to a hotspot location, a particular pickup location, a drop-off location, an event near the location, an entity near the location (e.g., a business, a party location, etc.), a time at which the request is received, a number of passengers associated with the request, an estimated time of arrival (ETA) of a vehicle for the transportation service (e.g., an ETA of the vehicle to the pickup and/or drop-off location), a rating of a driver, a type of vehicle for the transportation service (e.g., a vehicle allowed or restricted in a particular location, a make and/or model of vehicle, etc.), and the like.

In operation 406, the hardware-implemented payment adjustment module 230 calculates an adjusted price for the transportation service based on the modified pricing associated with the particular characteristic. The adjusted price can be the price that the passenger is to pay in exchange for the transportation service requested.

In some embodiments, the request for transportation relates to a hotspot location associated with a particular characteristic, and the request is provided to one or more drivers relevant to the particular characteristic. For example, the request is related to an ETA, a rating of a driver a type of driver, a type of vehicle, and the like, and the request may be sent to drivers associated with one or more of these characteristics. In a specific example, requests for transportation to an airport are sent to drivers who are not restricted from going to the airport.

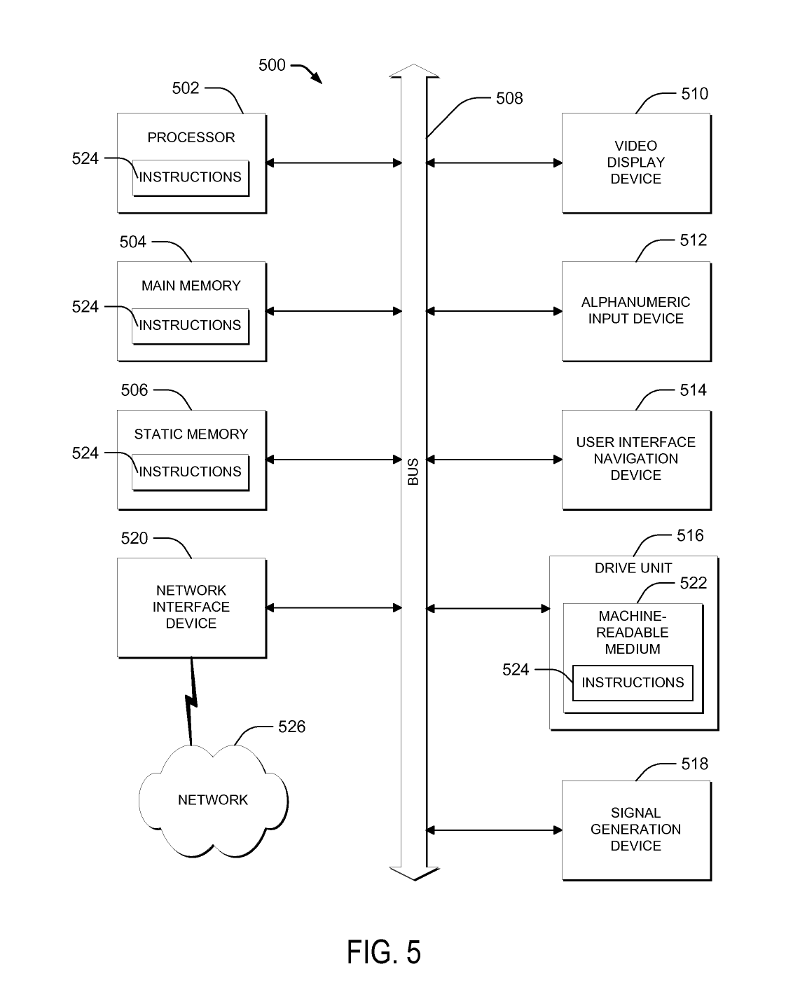

FIG. 5 is a block diagram of a machine in the example form of a computer system 500 within which instructions, for causing the machine to perform any one or more of the methodologies discussed herein, are executed. In alternative embodiments, the machine operates as a standalone device or is connected (e.g., networked) to other machines. In a networked deployment, the machine operates in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 500 includes a processor 502 (e.g., a central processing unit (CPU), a graphics processing unit (GPU) or both), a main memory 504, and a static memory 506, which communicate with each other via a bus 508. Computer system 500 further includes a video display device 510 (e.g., a liquid crystal display (LCD) or a cathode ray tube (CRT)). Computer system 500 also includes an alphanumeric input device 512 (e.g., a keyboard), a user interface (UI) navigation device 514 (e.g., a mouse or touch sensitive display), a disk drive unit 516, a signal generation device 518 (e.g., a speaker) and a network interface device 520.

Disk drive unit 516 includes a machine-readable medium 522 on which is stored one or more sets of instructions and data structures (e.g., software) 524 embodying or utilized by any one or more of the methodologies or functions described herein. Instructions 524 also resides, completely or at least partially, within main memory 504, within static memory 506, and/or within processor 502 during execution thereof by computer system 500, main memory 504 and processor 502 also constituting machine-readable media.

While machine-readable medium 522 is shown in an example embodiment to be a single medium, the term “machine-readable medium” includes a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present technology, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Instructions 524 are further be transmitted or received over a communications network 526 using a transmission medium. Instructions 524 are transmitted using network interface device 520 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

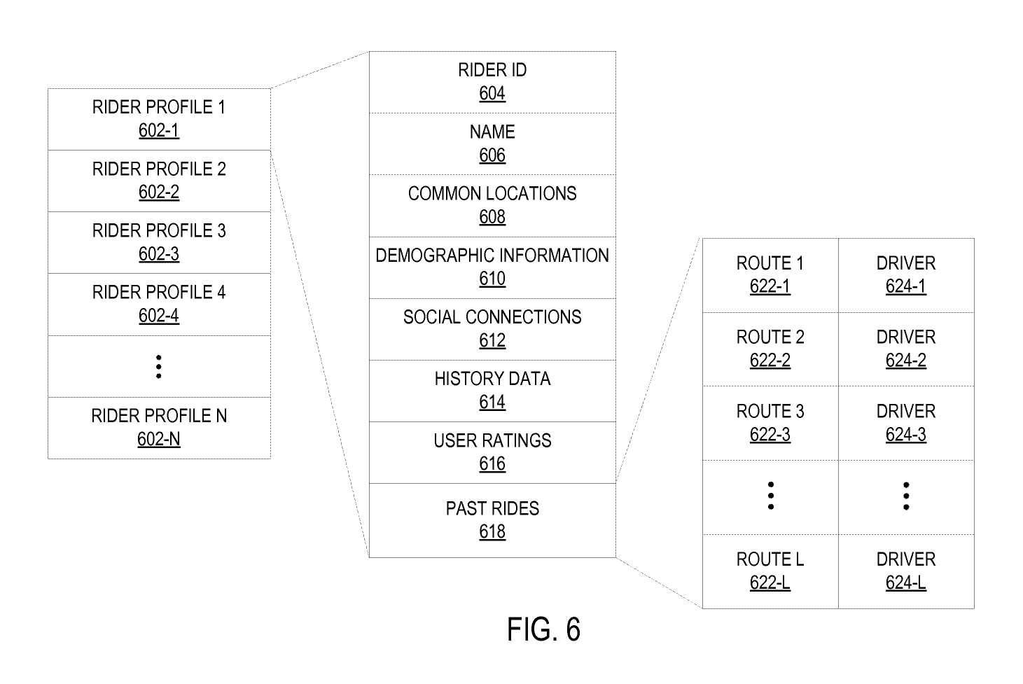

FIG. 6 depicts a block diagram of an exemplary data structure for the passenger record data for storing passenger (e.g. user) profiles at the transportation server, in accordance with some example embodiments. In accordance with some example embodiments, the passenger profile data includes a plurality of passenger profiles 602-1 to 602-N, each of which corresponds to a user that has registered with or otherwise interacted with the transportation server (e.g., server 104 in FIG. 1).

In some implementations, a respective passenger profile 602 stores a unique passenger ID 604 for the passenger profile 602, a name 606 for the passenger (e.g., the rider's legal name), common locations associated with the passenger 608 (e.g., home or word address, locations the passenger is likely to be when contacting the transportation server), demographic information about the passenger 610, social connections 612 (e.g., the passenger's friends and other connections), history data 614 (e.g., any data related to previous interactions with the transportation server), user ratings 616 (ratings from other users of the transportation server including drivers), and past rides 618.

In some implementations, a passenger profile 602 includes a list of past rides that the passenger has taken (622-1 to 622-L) and the drivers who provided those rides (624-1 to 624-L). Ride records include, but are not limited to, an origin location, a destination, and a fare (e.g., the price charged). In addition, the driver record 624 for each ride record represents the driver who provided the passenger to the rider. In some example embodiments, the ride records 622 can be used to calculate discounts, determine passenger patterns, and to generate predictions for the transportation server for the future. In some example embodiments, the driver record 624 includes a unique driver identification number so that the transportation server can record each ride that a driver has given.

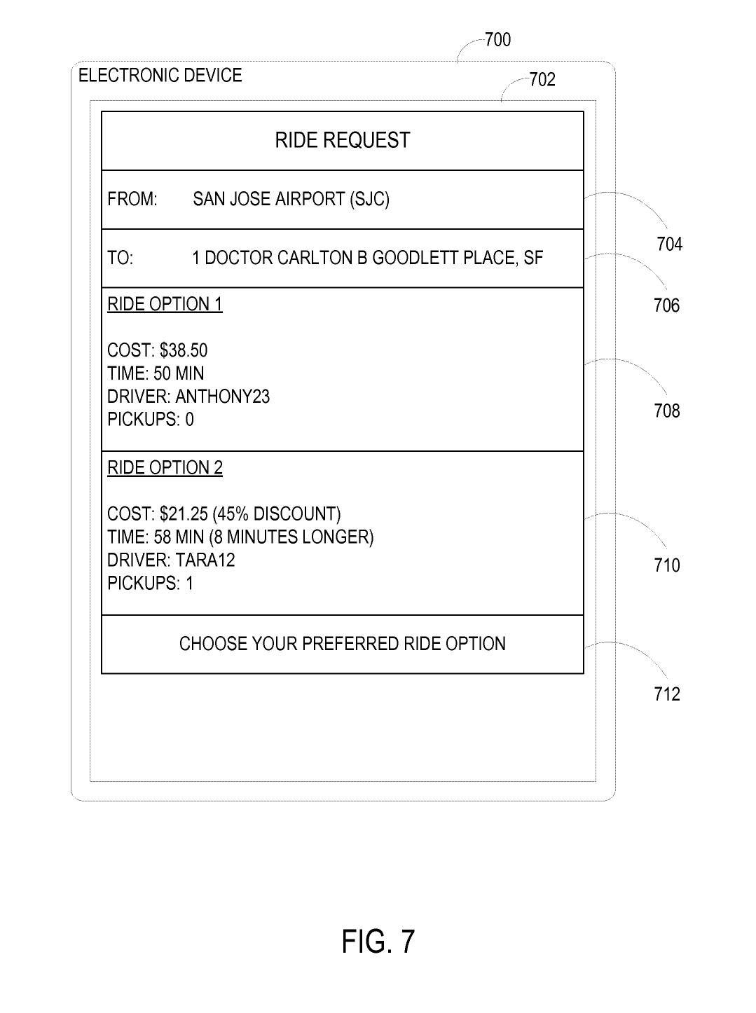

FIG. 7 illustrates an exemplary user interface of a client device 700 for requesting a ride. The electronic device 700 includes a display 702. In the display is a user interface that includes a user interface section name (e.g., ride request), an input area to enter a location or address from which the passenger is to be picked up 704, and an input area that allows a passenger to input his or her destination 706.

In some example embodiments, the transportation server (e.g., server 104 in FIG. 2) identifies one or more potential rides. In some example embodiments, one of the potential rides has an associated discount. In this example embodiment, the first ride option 708 is displayed along with information about the ride. For example, the cost (fare) of the ride is $38.50, the expected time is 50 minutes, the driver has an ID of “Anthony23,” and the are no pickups (e.g., the ride is not shared for any duration and the driver will make no stops to pick up or drop-off packages.).

In contrast, ride option 2 costs $21.45, which is a 45% discount. However, the total trip is estimated to take 58 minutes (an eight minute increase). Additionally, the driver will be Tara12 and there will be one pickup (e.g., the driver will pick up another passenger or package and the cost of the ride will be partially paid by another party.

The user interface also includes an element that allows the user to select the user's preferred ride option (712). For example, the user taps on the preferred ride option, which causes it to be highlighted or otherwise visually distinguished. The user can then confirm the choice by tapping on the “Choose Your Preferred Ride Option” button 712.

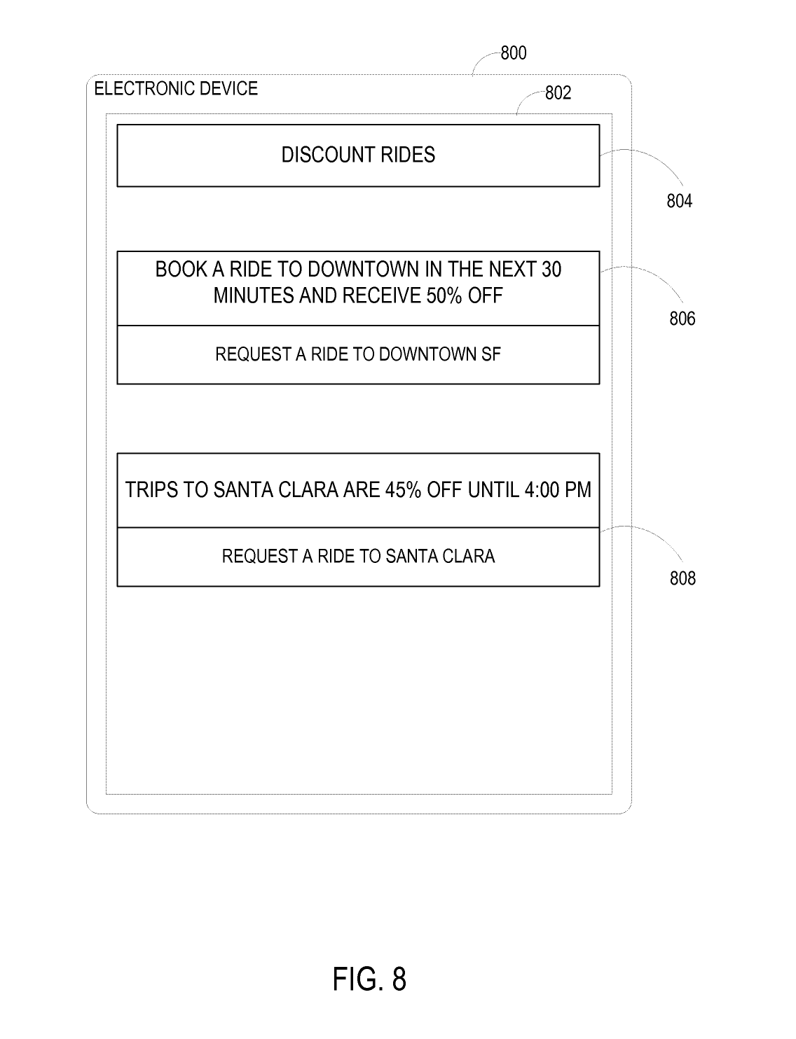

FIG. 8 illustrates an exemplary user interface of a client device 800 for reviewing discount options. The electronic device 800 includes a display 802. In the display is a user interface that includes a user interface section name (e.g., discount rides). In some example embodiments, the transportation server determines one or more areas that will have an increased need for drivers. For example, a business area of a city will have increased need for drivers around dinner time, as workers leave work and travel to dinner or home. In some example embodiments, the transportation server (e.g., server 104 in FIG. 2) creates one or more incentives for riders to take a ride that ends in an area with increased driver need. In this way, the transportation server can increase the supply of drivers in the area with high demand, without the drivers having to make non-paid trips to that area.

In some example embodiments, the user interface then displays one or more discounted ride options. In some example embodiments, the displayed options are based on information about the passenger associated with the electronic device 800, including the passenger profile data (e.g., data field 602 in FIG. 6). For example, the transportation server analyzes a user's common locations (e.g., data field 606 in FIG. 6), history data (e.g., data field 614 in FIG. 6), and past rides (e.g., data field 618 in FIG. 6).

The current user interface example shows two offers. The first is for discounted rides to downtown San Francisco 806. In some example embodiments, this offer is responding to increased demand for drivers in San Francisco after business hours end. The second offer is for a trip to Santa Clara before 4:00 PM 808. In some example embodiments, there is an American Football game at the Levi's stadium that ends at 4:00 PM and the transportation server is attempting to increase the supply of drivers in that area.

In some example embodiments, the user interface includes a user interface element (e.g., link or button) proximate to each offer that allows a user to request a ride that takes advantage of the offer.

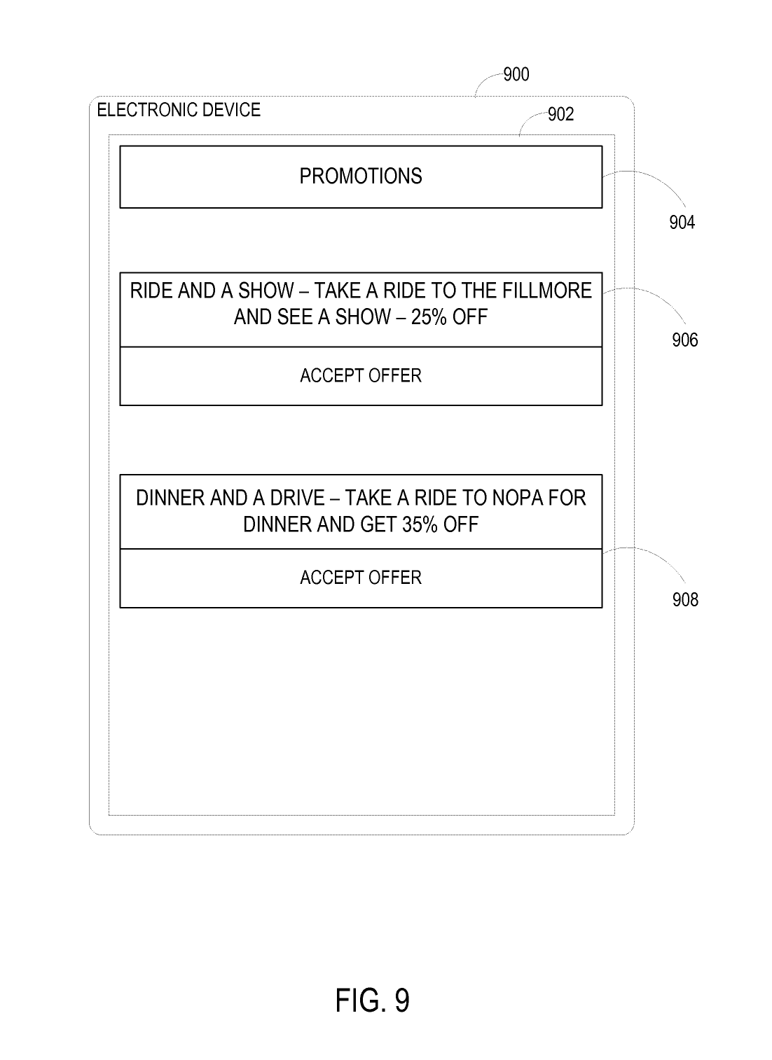

FIG. 9 illustrates an exemplary user interface of a client device 900 for reviewing promotional deals. The electronic device 900 includes a display 902. In the display is a user interface that includes a user interface section name (e.g., discount rides). In some example embodiments, one or more organizations (e.g., companies, non-profits, government organizations, and so on) can contract with the transportation server to offer promotions for their products and services through the transportation services. For example, a restaurant wants to increase the number of customers that come in on weekday evenings. The restaurant can enter into a contract with the transportation server to cover at least part of the fare of any user that is brought to the restaurant.

In some example embodiments, a user opens the “promotions” section of the user interface. In response all the promotions that are available to the user (based on factors outlined by the contracting organization including but not limited to location, demographic information of the user, time, date, the number of users who have already accepted the offer, and so on) are displayed in the user interface. In this example, two offers are displayed: one for a discount when getting a ride to a concert at the Fillmore 906, and one that offers a discount on rides to the restaurant NOPA 908. The user can then select the discount they want throughout the user interface.

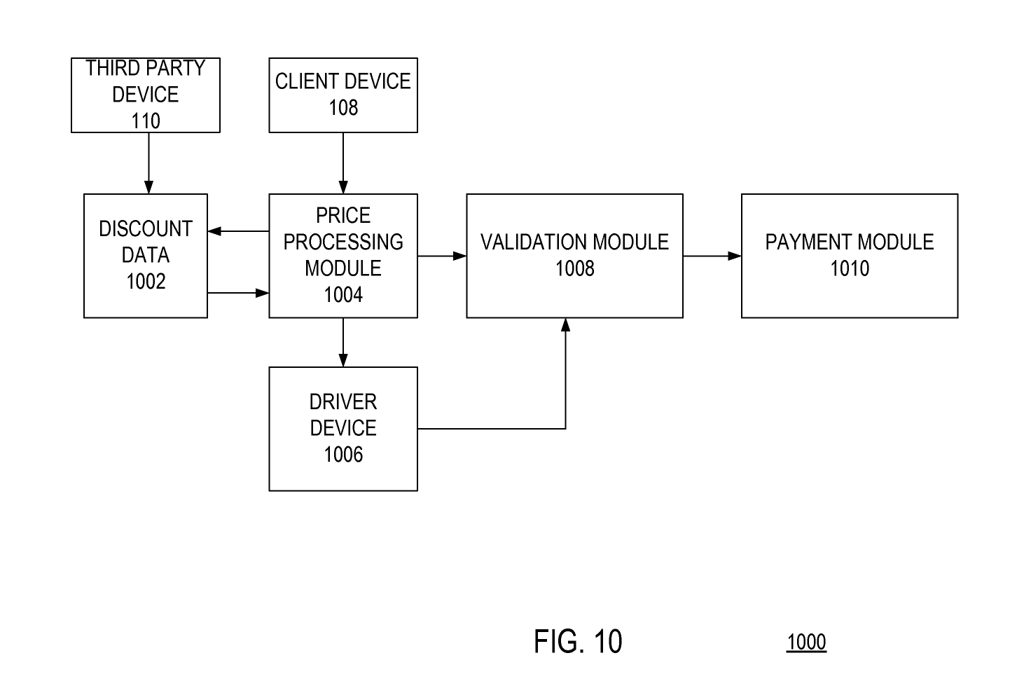

FIG.10 is a block diagram showing an example system for providing transportation discounts. In some example embodiments, the component blocks of FIG. 10 are grouped in a variety of ways to provide the same services. In some example embodiments, the transportation server (e.g., server 104 in FIG. 2) includes multiple depicted modules.

In some example embodiments, a third party device 110 determines one or more discount conditions. Example of discount conditions include, but are not limited to, the location that a passenger is picked up, the location that a passenger is dropped off, the date of the ride, the time of the ride, the number of persons riding, the rating of the rider, the rating of the driver, whether the passengers are connected to each other through a social network, and so on.

In some example embodiments, the third party device 110 is associated with an organization (e.g., a company) that is contracted with the transportation server 104 to promote goods and services offered by the organization. For example, a company can offer to partially pay for a riders fare if the passenger is being dropped off at their retail store.

In other example embodiments, the third party device 110 is associated with a user of the transportation server. For example, a high status user of the transportation server (e.g., server 104 in FIG. 2) sends data to the transportation server 104 designating their current location as a hotspot. In response the discount data 1002 is updated to enable users traveling the high status user's location to get a discount. In some example embodiments, only social connections of the high status user are eligible for the discount.

In some example embodiments, the discount conditions stored in the discount data 1002 are generated by the transportation server based on the needs of the server. For example, the transportation server determines that a large number of users are requesting rides from a certain high demand location at a certain time. In response the transportation server automatically updates the discount data 1002 to provide a discount to any user willing to travel to or near the into the high demand location.

In some example embodiments, the discount data module 1002 includes data about already schedule rides. In other example embodiments, the discount data module 1002 also includes information about package pick-ups and drop offs. Thus, the transportation can determine

In some example embodiments, the client device 108 (e.g., a device owned by a user) transmits a ride request to the price processing module 1004. The ride request includes a time, a pick up location, and a drop off location. Using this information, the price processing module 1004 accesses the discount data 1002 to determine whether the user associated with the client device 108 qualifies for any discounts. In some example embodiments, the ride request also identifies the user ID of the requesting user.

In some example embodiments, the price processing module determines one or more discounts (or promotions) available to the user of the client device 108. In some example embodiments, the discounts apply automatically (e.g., travelling to or from a hotspot or location that is needed by the transportation server). In other example embodiments, the discounts are optional (e.g., ride share, allow a pickup or drop-off of a package, and so on). In these cases, the price processing module 1004 transmits the optional discount offers to the client system 108. The user can then accept or reject each offer. Based on which offers, if any, the user accepts, the price processing module 1004 determines a final route and price for the ride.

In some example embodiments, the price processing module 1004 transmits the determined route to a driver device 1006 based on which drivers are available for the determined route. The price processing module 1004 also transmits the determined route to the validation module 1008. In some example embodiments, the validation module determines whether the user actually meets the conditions necessary to receive the discount.

In some example embodiments, the validation module 1008 receives data from the driver device 1006 (e.g., GPS location data and so on) that helps the validation module 1008 determine whether the user has meet the terms of the discount. For example, if the discount is contingent on the user being dropped off a certain store, the validation module 1008 ensures that the user actually arrives at that location based on the driver device data 1006. In some example embodiments, the user will opt to change routes while being driven and would therefore no longer qualify for some of the discounts.

In some example embodiments, discounts are validated by a validation module based on electronic records of credit cards payments, payment exchanges, or bank records. Thus, if the discount is based on a user purchasing goods or services from a particular stores (e.g., eating a meal at a restaurant), the user can allow the validation module 1008 to confirm the purchase through electronic payment records.

Similarly, the validation module 1008 can base a validation determination on records of an electronic currency (e.g., crypto currency) exchange records. Thus, the user can give the validation module 1008 a number associated with the users electronic currency account and the validation module 1008 can determine whether the user fulfilled the aspects of the discount based on the provided records.

In some example embodiments, the party providing the discount (e.g., a store or venue) will send a confirmation signal to the validation module 1008 based on a user checking in. For example, a concert venue allows uses to give their transportation server identification number or user name to the venue. The venue then sends a signal to the validation module 1008.

In some example embodiments, the validation module 1008 determines whether a user has met the conditions associated with a discount based on using one or more scanning technologies, including near field communication (NFC) tags, radio frequency identification (RFID), barcode scanning, logging onto a local network, and so on. Once the client device has logged in using the scanning technologies, the validation module 1008 is notified and determines that the user has met the conditions of the discount.

In some example embodiments, the client device logs into a location based on a geo-located check-in location. In some example embodiments, this is based on GPS data tracked by the client device or the driver device. In some example embodiments, the GPS location is determined through a third-party service or through the transportation server.

In some example embodiments, the validation is made based on showing an image to the passenger or the passenger (e.g. validation is showing a photo of a tiger). In some example embodiments, the validation is made by an image of the passenger that is confirmed by an agent at the drop-off location (e.g., validation by an employee of a business to which the passenger is taken). In some example embodiments, the validation module 1008 validates the actions based on a provided electronic receipt. For example, the user purchases a meal at a restaurant. The user then sends an electronic receipt provided by the restaurant to the validation module 1008 to confirm that the user has met the conditions of the discount (in this case purchasing a meal at a specific restaurant.

In some example embodiments, the validation module 1008 determines whether the user has met the conditions of the discount. In accordance with a determination that the user has met the conditions (e.g., the GPS data shows the user was dropped off at the right location), the validation module 1008 sets a final price based on the discount and transmits it to the payment module 1010.

In some example embodiments, In accordance with a determination that the user has not met the conditions (e.g., the user changes the established route), the validation module, calculates the cost of the ride without the discount and transmits the discounted value to the payment module 1010. The payment module 1010 then collects calculated amount.

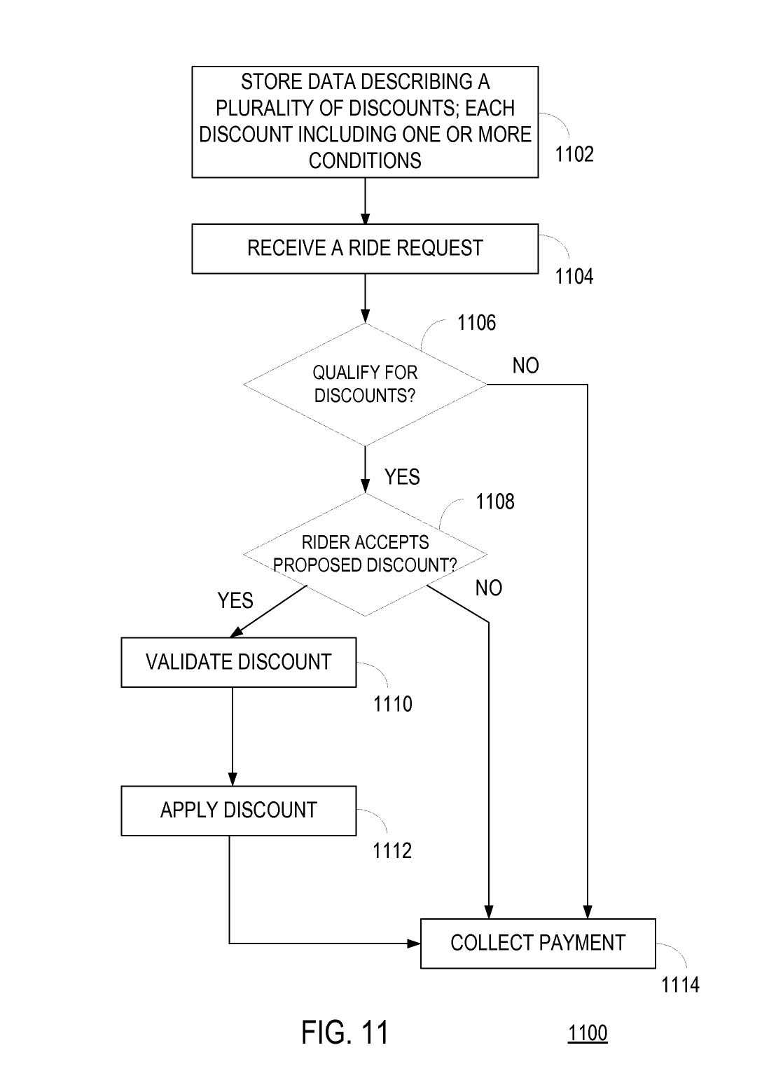

FIG. 11 is a flow diagram illustrating a method, in accordance with some example embodiments, for providing discounts in a transportation service. Each of the operations shown in FIG. 11 correspond to instructions stored in a computer memory or computer-readable storage medium. In some embodiments, the method described in FIG. 11 is performed by the transportation server (e.g., server 104 in FIG. 2). However, the method described can also be performed by any other suitable configuration of electronic hardware.

In some embodiments the method is performed at a transportation server (e.g., server 104 in FIG. 2) including one or more processors and memory storing one or more programs for execution by the one or more processors.

In some example embodiments, the transportation server (e.g., server 104 in FIG. 2) stores (1102) discount data describing a plurality of discounts. Each discount has one or more associated conditions. In some example embodiments, the discount data is generated from data at the transportation server (e.g., server 104 in FIG. 2). In some example embodiments, the transportation server (e.g., server 104 in FIG. 2) determines that a particular location is important based on the amount of traffic to or from the location. As a result, the transportation server (e.g., server 104 in FIG. 2) generates a discount for the location and stores it in a database at the transportation server (e.g., server 104 in FIG. 2).

In some example embodiments, the discount data is received from a passenger, a driver, or a third party. For example, a particular user is having a party and establishes a discount with the transportation server (e.g., server 104 in FIG. 2) so that his or her guests can come to the party at a reduced cost. In another example, instead of hiring a valet, a party host sets up a hotspot location, providing free rides if the host's hotspot location is the destination and entered as the party host's name.

In some example embodiments, the transportation server (e.g., server 104 in FIG. 2) receives (1104) a ride request. In some example embodiments, the ride request includes one or more of the user identification of the requesting user, a preferred driver, a pick-up location, a pick up time, a drop-off time, a drop off location, and so on.

In some example embodiments, based on the ride request, the transportation server (e.g., server 104 in FIG. 2) determines (1106), based on the ride request, whether the ride qualifies for any discounts represented in the stored discount data.

In some example embodiments, the discounts are based on the identification of the driver, the passenger, and/or an entity (e.g., a business) associated with a pickup and/or drop-off location. For example, the transportation server (e.g., server 104 in FIG. 2) determines the number of prior trips by the passenger and generates specific discounts based on the number of trips of the passenger. In some example embodiments, the passenger receives a discount on their first ever ride with the transportation server (e.g., server 104 in FIG. 2). In some example embodiments, the passenger has enough trips to qualify for a frequent customer incentive program.

In some example embodiments, the transportation server (e.g., server 104 in FIG. 2) determines number of prior trips by the driver and determines a discount.

In some example embodiments, the transportation server (e.g., server 104 in FIG. 2) includes discounts based on weather conditions at pickup locations, drop-off locations, intermediate stops, and so on. For example, if the transportation server (e.g., server 104 in FIG. 2) determines, based on available weather information, that a given location is experiencing heavy rains, it can create a discount for passengers waiting to leave that area. This discount can then be advertised (e.g., sent to potential passengers as an e-mail or text message). In some example embodiments, the weather discounts are generated automatically.

In some example embodiments, discounts can be generated based on specific events, such as games, concerts, parties, and so on. The transportation server (e.g., server 104 in FIG. 2) determines that during a specific event (a parade for example) rides to and from the event receive a discount. In some example embodiments, this discount can be funded by the organization associated with the event.

In some example embodiments, the date and time are used to determine discounts. For example, certain holidays result in discounts for the riders. In some example embodiments, the discounts are based on the demographics of the riders and or drivers.

In some example embodiments, the transportation server (e.g., server 104 in FIG. 2) determines that there are multiple riders in the vehicle and generates discounts when they are connected on a social network (e.g., rewarding passengers for taking rides with their friends). In some example embodiments, the transportation server (e.g., server 104 in FIG. 2) establishes discounts when a registered user brings a co-passenger that has not used the transportation server (e.g., server 104 in FIG. 2) previously.

In some example embodiments, the driver and/or passenger receive discounts or bonus when one of them adds the other to their list of favorite drivers or passengers. In some example embodiments, passengers can request specific modes of travel (e.g., a car, a truck, a vehicle with a bike rack, and so on). In some example embodiments, there are specific discounts established for certain modes of travel.

In some example embodiments, a third party (e.g., a restaurant) establishes a keyword associated with an event or a location. Users can then request a ride to the location or event using the specific keyword. In this way, the user does not need to know the specific location of the event, but the transportation server (e.g., server 104 in FIG. 2) will translate the keyword into a specific destination. This is especially useful for an event that changes location (e.g., a club that uses different locations to hold meetings). The transportation server (e.g., server 104 in FIG. 2) then grants a discount for the user.

In some example embodiments, the transportation server (e.g., server 104 in FIG. 2) establishes discount based on whether the passenger has added information about future rides (e.g., establishing a more predictable schedule of future rides). Advance scheduling increases the ability of the transportation server (e.g., server 104 in FIG. 2) to efficiently plan rides for users and is therefore desirable for the transportation server (e.g., server 104 in FIG. 2). For example, a passenger requests a ride from home to work every day. Each ride receives a discount.

In some example embodiments, certain discounts are applied automatically (e.g., a discount for travelling on a specific holiday or to a specific location.). In other example embodiments, certain discounts are only applied when the user consents. For example, if a user requests a ride, the transportation server (e.g., server 104 in FIG. 2) can determine that the path of the ride has significant overlap with another requested ride. In this case, the transportation server (e.g., server 104 in FIG. 2) offers each passenger the opportunity to share a ride and receive a reduced fare.

In other example embodiments, a discount is offered to a user based on whether the user shares information about the ride on a social network (e.g., Twitter, Facebook, Instagram, and so on). In some example embodiments, the transportation server (e.g., server 104 in FIG. 2) also co-ordinates package delivery. The transportation server (e.g., server 104 in FIG. 2) determines that the path of the passenger would allow a package to be dropped off. In this case, the user can opt to allow the package delivery and received a reduced rate.

In some example embodiments, the transportation server (e.g., server 104 in FIG. 2) determines (1110) whether the user has met the conditions of the discount. IF so, the discount is applied (1112) applicant and payment is received (1114). If not, the discount is not applied, and payment is collected (1114).

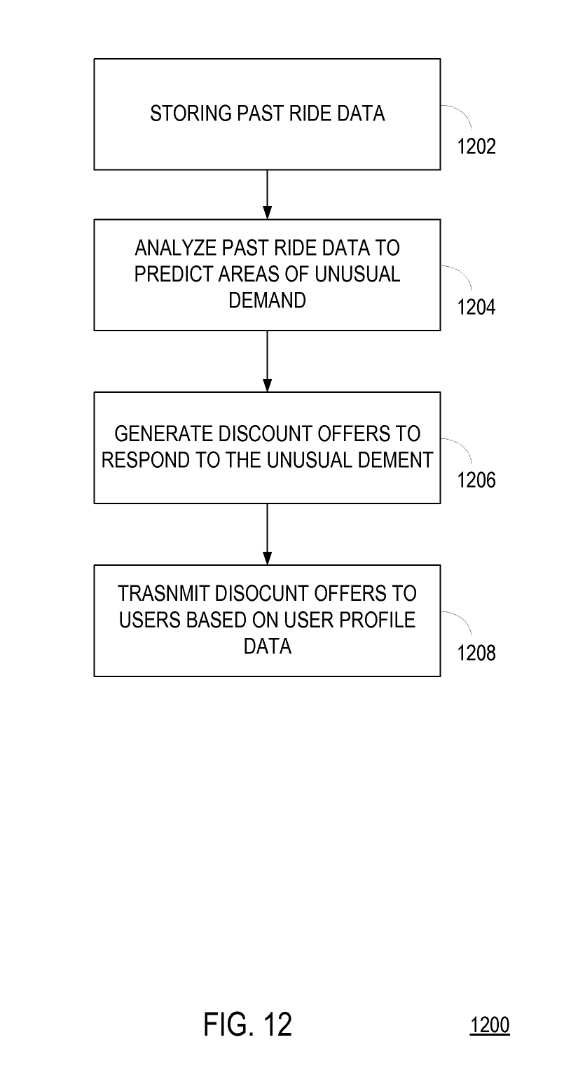

FIG. 12 is a flow diagram illustrating a method, in accordance with some example embodiments, for generating passenger discounts in a transportation service. Each of the operations shown in FIG. 12 correspond to instructions stored in a computer memory or computer-readable storage medium. In some embodiments, the method described in FIG. 12 is performed by the transportation server (e.g., server 104 in FIG. 2). However, the method described can also be performed by any other suitable configuration of electronic hardware.

In some embodiments the method is performed at a transportation server (e.g., server 104 in FIG. 2) including one or more processors and memory storing one or more programs for execution by the one or more processors.

In some example embodiments, the transportation server (e.g., server 104 in FIG. 2) stores (1202) a large amount of past ride data. In some example embodiments, the past ride data details the rides that were request and include the location of pick up, the location of drop off, the date, the time, any events associated with each ride, the driver, the passenger, and so on.

In some example embodiments, using this data set, the transportation server (e.g., server 104 in FIG. 2) is able to determine one or more areas and times that will have unusual demand. Unusual demand includes situations where there are a lot of ride requests from an area, but few drivers in the area to meet them and situations where there are many drivers in an area but few rides requested. Unusual demand can be predicted in cases where there will be significantly more people being dropped off in an area (e.g., for an event) than will be leaving or in cases where there are an abnormally high number of people leaving an area (e.g., the end of the work day) and few people enters.

In some example embodiments, in response to predicting a future area of unusual demand, the transportation server (e.g., server 104 in FIG. 2) automatically generates (1206) discount offers intended to balance the demand. For example, if a concert is ending at 11 PM, the transportation server (e.g., server 104 in FIG. 2) creates offers for rides ending near the venue at a time near 11 PM so that the driver can then respond to the ride request of a user leaving the venue.

In some example embodiments, the transportation server (e.g., server 104 in FIG. 2) determines that there will be too many drivers dropping off passengers at an event (e.g., all day conventions like ComiCon) but not enough riders seeking to leave that location at the appropriate time. The transportation server (e.g., server 104 in FIG. 2) can then automatically generate a discount offer for passengers leaving the vicinity of the event during the time of the most drop offs. In this way, drivers can more reasonable expect return trips from their drop offs and not have to make a long empty car trip to another pickup (e.g., a dead head).

In some example embodiments, the transportation server (e.g., server 104 in FIG. 2) then transmits (1208) the generated offers out to users based on information stored in a user profile. For example, if a user has frequently requested a ride to downtown San Francisco and the current discount is to that area, they are selected to receive the discount notifications. In some example embodiments, the discounts are all publicly posted on a website associated with the transportation server (e.g., server 104 in FIG. 2).

Certain embodiments are described herein as including logic or a number of components, modules, or mechanisms. Modules constitute either software modules (e.g., code embodied on a machine-readable medium or in a transmission signal) or hardware modules. A hardware module is a tangible unit capable of performing certain operations and is configured or arranged in a certain manner. In example embodiments, one or more computer systems (e.g., a standalone, client or server computer system) or one or more hardware modules of a computer system (e.g., a processor or a group of processors) is configured by software (e.g., an application or application portion) as a hardware module that operates to perform certain operations as described herein.

In various embodiments, a hardware module is implemented mechanically or electronically. For example, a hardware module comprises dedicated circuitry or logic that is permanently configured (e.g., as a special-purpose processor, such as a field programmable gate array (FPGA) or an application-specific integrated circuit (ASIC)) to perform certain operations. A hardware module m also comprises programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

Although an embodiment has been described with reference to specific example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments.

Combinations of the above embodiments, and other embodiments not specifically described herein, will be apparent to those of skill in the art upon reviewing the above description.

What is claimed is:

1. A method comprising:
receiving, from a client device of a user, a request for a transportation service;
identifying, at a server, that the request relates to a particular characteristic associated with modified pricing; and
calculating, at the server, an adjusted price for the transportation service based on the modified pricing associated with the particular characteristic.

2. The method of claim 1, wherein the particular characteristic includes at least one of a pickup location, a drop-off location, an event near the geographic location, an entity near the geographic location, a time at which the request is received, a number of passengers associated with the request, an estimated time of arrival of a vehicle, a rating of a driver, and a type of vehicle.

3. The method of claim 1, further comprising:
storing, at a database associated with the transportation service, discount data, wherein the discount data describes one or more discounts available from the transportation service.

4. The method of claim 3, wherein the discount data includes one or more conditions for each discount in the one or more discounts available from the transportation service.

5. The method of claim 4, wherein the request for a transportation service includes at least one of information identifying the requesting user, a pickup location, a drop off location, and a time.

6. The method of claim 5, wherein identifying that the request relates to a particular characteristic associated with modified pricing further comprises:
using information received with the request for a transportation service, selecting one or more discounts for which the request meets the one or more conditions.

7. The method of claim 1, further comprising:
transmitting an offer to the client device a discount offer, wherein the discount offer includes the adjusted price.

8. The method of claim 1, further comprising:
receiving, from the client device, user acceptance of the discount offer; and
in response to receiving user acceptance of the discount offer, adjusting the actual price based on the accepted discount

9. A machine-readable storage medium storing instructions which, when executed by one or more processors, cause the one or more processors to perform operations comprising:
receiving, from a client device of a user, a request for a transportation service;
identifying that the request relates to a particular characteristic associated with modified pricing; and
calculating an adjusted price for the transportation service based on the modified pricing associated with the particular characteristic.

10. The machine-readable storage medium of claim 9, wherein the particular characteristic includes at least one of a pickup location, a drop-off location, an event near the geographic location, an entity near the geographic location, a time at which the request is received, a number of passengers associated with the request, an estimated time of arrival of a vehicle, a rating of a driver, and a type of vehicle.

11. The machine-readable storage medium of claim 9, further comprising:
storing, at a database associated with the transportation service, discount data, wherein the discount data describes one or more discounts available from the transportation service.

12. The machine-readable storage medium of claim 11, wherein the discount data includes one or more conditions for each discount in the one or more discounts available from the transportation service.

13. The machine-readable storage medium of claim 12, wherein the request for a transportation service includes at least one of information identifying the requesting user, a pickup location, a drop off location, and a time.

14. The machine-readable storage medium of claim 13, wherein identifying that the request relates to a particular characteristic associated with modified pricing further comprises:
using information received with the request for a transportation service, selecting one or more discounts for which the request meets the one or more conditions.

15. The machine-readable storage medium of claim 9, further comprising:
transmitting an offer to the client device a discount offer, wherein the discount offer includes the adjusted price.

16. The machine-readable storage medium of claim 9, further comprising:
receiving, from the client device, user acceptance of the discount offer; and
in response to receiving user acceptance of the discount offer, adjusting the actual price based on the accepted discount

17. A system comprising:
a hardware-implemented input module configured to receive, from a client device of a user, a request for a transportation service; and
a hardware-implemented location determination module configured to:
identify that the request is associated with a hotspot location, the hotspot location being a geographical location associated with a particular characteristic; and
provide the request for the transportation service to at least one transportation provider relevant to the particular characteristic.

18. The system of claim 17, wherein the particular characteristic is related to at least one of an estimated time of arrival of a vehicle, a rating of a driver, a type of driver, a pickup location, a drop-off location, and a type of vehicle.

19. The system of claim 17, wherein the request for a transportation service includes at least one of information identifying the requesting user, a pickup location, a drop off location, and a time.

20. The system of claim 17, further comprising a hardware-implemented storage module to store a plurality of hotspot locations.
